(19) United States
(12) Patent Application Publication
(10) Pub. No.: US 2007/0074932 A1
(43) Pub. Date: Apr. 5, 2007

(54) Padding device for use with ladders

(76) Inventor: Robert Mutscheller, Waynesboro, VA (US)

Correspondence Address: CALFEE HALTER & GRISWOLD, LLP, 800 SUPERIOR AVENUE, SUITE 1400, CLEVELAND, OH, 44114, US

(21) Appl. No.: 11/229,819

(22) Filed: Sep. 19, 2005

(51) Int. Cl. E06C 7/42

(52) U.S. Cl. 182/107

(57) ABSTRACT

According to one embodiment of the present invention, a padding device is provided that is adapted to attach to the steps or rungs of a ladder to cushion the step or rung thereby providing comfort and protection to the legs and shins of an individual who is using the ladder.

### TECHNICAL FIELD

The present invention relates generally to a ladder rung padding device. More particularly, the present invention relates to a ladder rung padding device that is adapted to attach to the individual steps or rungs of a ladder to cushion the step or rung to which it is attached, thereby providing comfort and protection to the legs and shins of an individual who is using the ladder.

### BACKGROUND OF THE INVENTION

When using a ladder, it is common for the user to stand on the step or rung of the ladder and rest his/her legs or shins against other steps or rungs of the ladder to stabilize and brace themselves while they are using the ladder. In this manner, the user can sufficiently stabilize themselves to free one or both of their hands to accomplish the task they are working on. If the users legs are unprotected, there is the potential for the user's legs or shins to become sore or injured from resting against the surface of the ladder's steps or rungs. The purpose of an embodiment of the present invention, therefore, is to provide a padding device that cushions the steps or rungs of a ladder to provide comfort and protection to the user's legs while the user is leaning against the steps or rungs of the ladder.

### SUMMARY OF THE INVENTION

Accordingly, an embodiment of the present invention provides a padding device that cushions the individual steps or rungs of a ladder and thereby provides comfort and protection to the legs and shins of an individual who is using the ladder.

### BRIEF DESCRIPTION OF THE DRAWINGS

FIG. 1A is a perspective view of one embodiment of a padding device of the present invention;

FIG. 1B is a perspective view of an additional embodiment of a padding device of the present invention;

FIG. 2 is an exploded perspective view of the padding device of FIG. 1A;

FIG. 3A is a perspective view of an additional embodiment of a base of a padding device having a U-shaped cross-section;

FIG. 3B is a perspective view of an additional embodiment of a base of a padding device in the shape of a portion of a cylinder;

FIG. 3C is a perspective view of an additional embodiment of a base of a padding device having a triangular shaped cross-section;

FIG. 3D is a perspective view of an additional embodiment of a base of a padding device having a generally flat front wall with two arc-shaped side walls; and

FIG. 4 is a cross sectional view of an additional embodiment of the padding device of the present invention.

### DETAILED DESCRIPTION OF THE INVENTION

An embodiment of the present invention relates generally to a padding device and, in particular, to a padding device that is adapted to attach to the individual steps or rungs of a ladder to cushion the step or rung to which it is attached, thereby providing comfort and protection to the legs and shins of an individual who is using the ladder. While this invention is susceptible of embodiment in many different forms, specific embodiments are shown in the drawings and will be described herein in detail, with the understanding that the present disclosure is to be considered as an exemplification of the principles of the invention, and is not intended to limit the invention to the specific embodiments illustrated. The invention is applicable to padding devices of varying constructions for the padding of the individual steps of rungs of ladders.

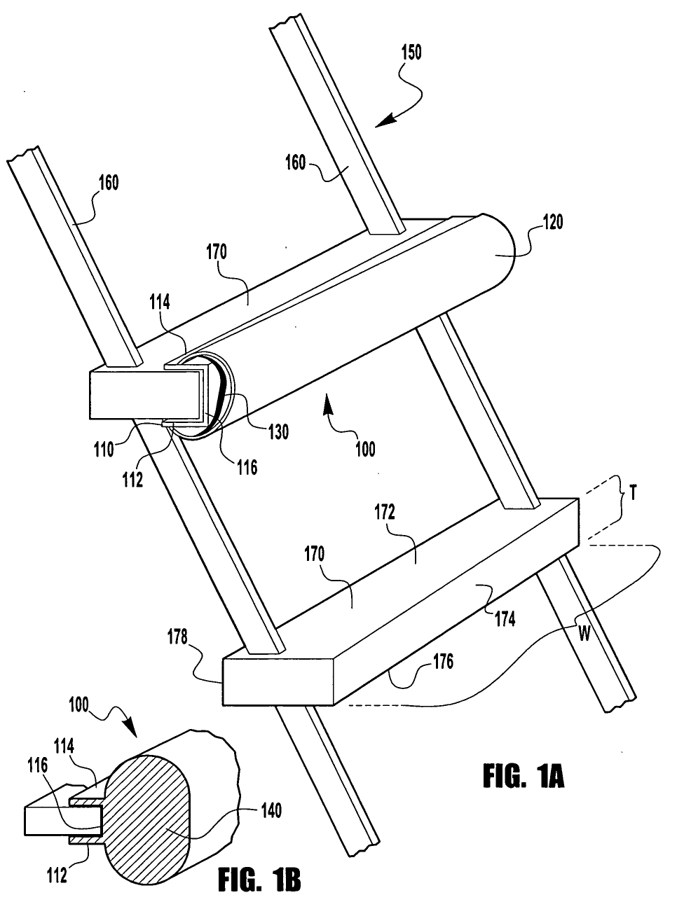

As representative of the invention, FIG. 1 illustrates a padding device 100 in accordance with a first embodiment of the invention. As shown in FIG. 1A, the padding device 100 of the illustrated embodiment generally includes a base 110 having opposing sidewalls 112 and 114, and a front wall 116, which cooperate to engage with a ladder step or rung, a pad 130, and a cover 120. In alternate embodiments the padding device 100 could be made up of different combinations of the base, pad and cover components. For instance, the padding device could be a single integrated unit, as shown in Fig. 1B, and according to such embodiments the padding device 100 including a base 110 that includes a pad portion 140, wherein the pad portion 140 is attached to or integrated with the front wall 116. The base may further comprise a pocket (not shown) attached to or integrated with one or more of the sidewalls 112 and 114 and front wall 116 of the device, said pocket adapted to receive a pad 130. In yet other embodiments, the padding device 100 could be a base 100 and a cover 120, wherein the cover 120 includes a pocket (not shown), said pocket adapted to receive a pad 130.

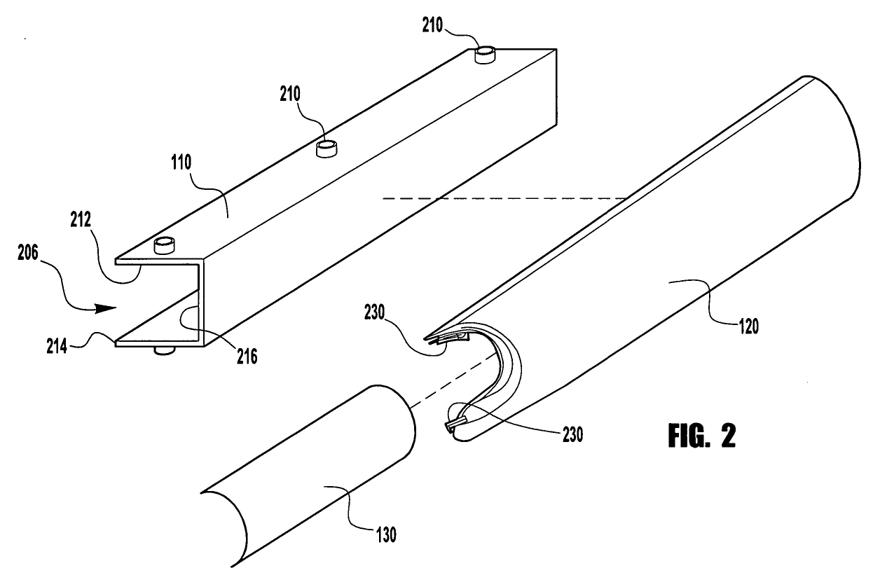

The padding device 100 of the illustrated embodiment of the present invention includes a base 110. As shown in FIG. 1, a ladder 150 commonly has a pair of side rails 160 and a plurality of steps or rungs 170. The configuration of the base 110 is adapted to attach to the individual steps or rungs 170 of a ladder 150. Generally, each of the steps or rungs 170 of the ladder 150 has a top face 172, a front face 174, bottom face 176, and back face 178. As seen in FIG. 2, the base 110 of the illustrated embodiment of the padding device 100 is generally C-shaped when viewed from its side, i.e. the left in FIG. 2, and includes an opening 206 that is defined by an interior front wall surface 216 and a pair of interior side wall surfaces 212 and 214 that extend from the interior front wall surface 216 to form the opening 206. As shown in FIG. 1, in the illustrated embodiment, the step or rung of the ladder 170 fits within the opening 206 of the base 110 and the pair of side wall surfaces 212 and 214 clamp against the top face 172 and bottom face 176 of the ladder rung, and the interior front wall surface 216 is in contact with the front face 174 of the ladder rung. In this manner, the base 110 substantially encloses the front face 174 while also enclosing at least a portion of both the top face 172 and bottom face 174 of the ladder rung.

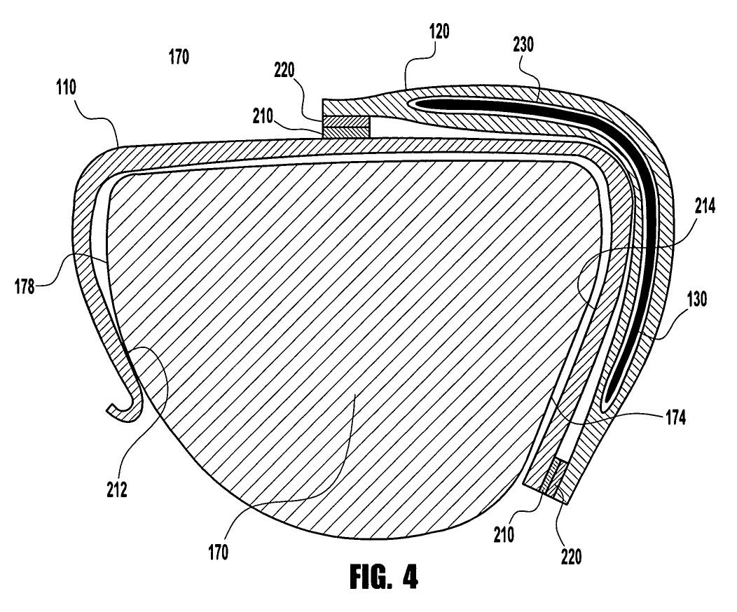

Many different types of ladders exist, such as extension ladders and step ladders, each possessing steps and rungs of various shapes and configurations. It should be apparent to those skilled in the art that the padding device 100 could be constructed for use with ladder steps and rungs of varying construction. It should also be apparent that the padding device 100 could be constructed to engage with the steps or rungs of a ladder in various ways. For example, in alternative embodiments, the pair of side wall surfaces 212 and 214 could clamp against the front face 174 and back face 178 of the ladder rung, and the interior front wall surface 216 could be in contact with the top face 172 of the ladder rung. In this manner, the base 110 substantially encloses the top face 172 while also enclosing at least a portion of both the front face 174 and back face 178 of the ladder rung. The padding device 100 illustrated in FIG. 4 is shown in use with a ladder rung 170 of a typical extension ladder, which has a generally semi-circular cross section. As mentioned throughout this disclosure, however, it should be apparent that the padding device 100 could be configured so as to be used with ladder rungs or steps 170 of varying shape and size.

The base 110 is molded from a pliable, durable material such as metal, plastic, rubber, nylon, vinyl, or PVC, but other suitable materials can also be used. The pliable material of the base 110 allows the interior side walls 112 and 114 of the base to bend outward and then return to their original position, thus allowing the base to be snugly slid onto a rung or step 170 of a ladder. The material of the base 110 is sufficiently flexible to allow the side walls 112 and 114 to flex as the base is slid over the ladder rung 170 yet having sufficient rigidity to allow the side walls to hold the base firmly in position on the ladder rung once the base is slid into place. In this manner, the base 110 can be easily slid onto and removed from a rung or step 170 of a ladder with one hand. This ease of installation and removal allows the user of the ladder to install and remove the padding device 100 as the user moves up and down or side to side on the ladder while still having one hand free. Accordingly, an individual using the padding device 100 can easily change the location of the device with one hand as they climb up or down the ladder to accomplish various tasks.

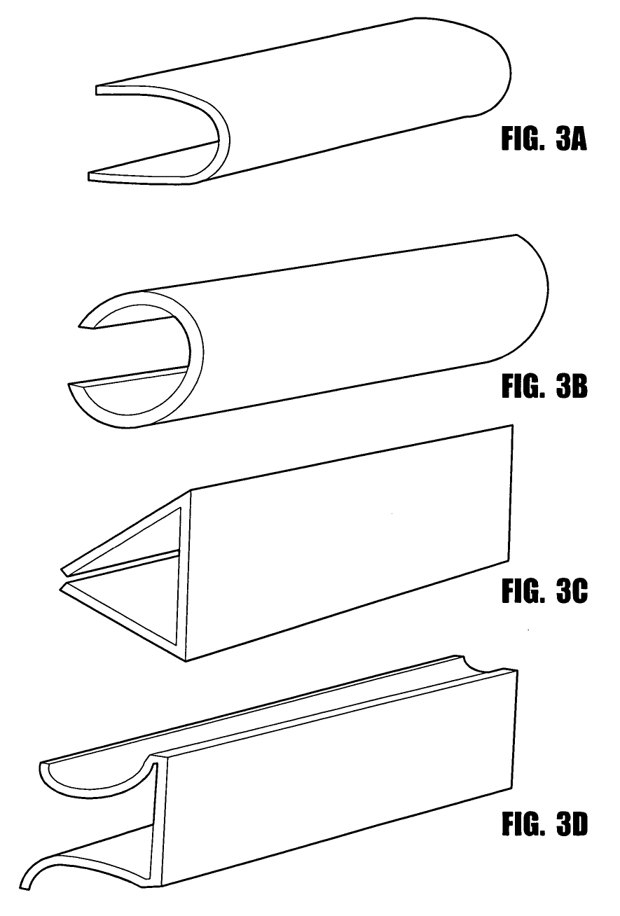

The ladder rung as depicted in FIG. 1A has substantially flat faces 172, 174, 176 and 178. It should be apparent to one skilled in the art, however, that the construction of ladders varies greatly and the steps or rungs of the ladder could be configured differently. For example, a ladder could include rungs with a circular cross-section, or other shape. It should be noted that the base 110 of the padding device 100 could be adapted to attach to and enclose, either fully or partially, a ladder rung with a cross-section of any shape or size. Accordingly, the shape of the base 110 could also vary greatly and is not limited to the C-shaped base of the illustrated embodiment. For example, the base 110 could be U-shaped when viewed by its side, as shown in FIG. 3A, or take the shape of a portion of a cylinder as shown in FIG. 3B. The base 110 could also have a generally triangular shape, with a front wall 116 and two side walls 112 and 114 that extend from the front wall 116 to form a triangle, as shown in FIG. 3C. In addition, the base 110 could have a generally flat front wall 116 with two arced side walls 112 and 114 that extend from the front wall 116, as shown in FIG. 3D. Finally, it should be apparent to someone skilled in the art that the shape and configuration of the base 110 are not limited to the shape and configuration disclosed by the illustrated embodiments, and the shape of the base could have many different shapes, and the size and orientation of the front wall 116 and side walls 112 and 114 could have different orientations, in addition to those shown. Since the padding device 100 is not intended to offer safety or stability while standing on a ladder rung, it is not necessary for the padding device 100 to conform precisely to the shape of a ladder rung or step.

It should also be understood that the dimensions of the base 110 could vary greatly. The dimensions, such as the width (W) or thickness (T), of the steps or rungs 170 of ladders can differ significantly. Accordingly, the dimensions of the base 110 could be adapted to fit a step or rung of any dimension. Generally, the dimensions of the base 110 should be adapted to cover a sufficient amount of the width (W) of the step or rung 170 to protect the legs or shins of the user from contacting the step or rung. While the dimensions of base 110 can be specifically tailored to ladders steps or rungs of specific dimensions, the dimensions of the base 110 can be also configured so that one particular base 110 could be compatible with a wide range of ladder step or rung sizes. In some embodiments, the base 110, either alone, or together with the cover 130, could completely cover the three or more faces of a step or rung.

Optionally, the base 110 may include a plurality of fasteners 210. As shown in FIG. 2, the base 110 of the illustrated embodiment includes a plurality of snap fasteners 210. The padding device 100 of this application is not limited to snap fasteners, however, and several other types of fasteners could be used, such as Velcro, inter-engaging slots and tabs, a tongue and groove arrangement, screws, glues or other adhesives, etc.

Optionally, the padding device 100 includes a cover 120. As seen in FIG. 2, the cover 120 of the illustrated embodiment is generally a portion of a cylinder, but other shapes could also be used. The cover 120 of the padding device 100 of the illustrated embodiment is adapted to attach to the base 110. In the illustrated embodiment, the cover 120 generally surrounds and encloses the front wall 202 and side walls 204 of the base 110, as shown in FIG. 1. Preferably, the cover 120 is constructed from a flexible, durable material such as plastic, rubber, nylon, vinyl, fleece, or cloth, but other suitable materials can also be used. Preferably, the material chosen for the cover 120 will be flexible enough to allow the cover to conform to the shape of the base and adequately surround and enclose the base. There are many different applications that ladders are used for, such as general repair work, painting, and window washing, It should be understood that the material and texture of the cover 120 could be modified to provide comfort and/or safety features that would be advantageous for different types of ladder use. For instance the cover could be constructed from a material that is resistant to water to prevent the cover form absorbing water when it is used in a wet environment. Also the exterior surface of the cover 120 could be textured to prevent the users legs or shins from slipping if they are rested against the cover or to provide other safety or comfort features.

In the illustrated embodiment, the cover 120 includes a plurality of snap fasteners 220 that correspond with the snap fasteners 210 of the base. As a result, the cover 120 is attached to the base 110 and is removable from the base. As mentioned previously, however, the padding device 100 of this application is not limited to snap fasteners and several other types of fasteners could be used, such as Velcro, inter-engaging slots and tabs, a tongue and groove arrangement, screws, glues or other adhesives, etc to connect the cover 120 and the base 110. In addition, the cover 120 and the base 110 could be of unitary construction and not be capable of being separated.

In the illustrated embodiment, a pocket 230 is defined within the cover 120 as shown in FIG. 2. The dimensions of the pocket 230 can vary. The pocket 230 could be substantially the same size as the cover 120 itself or the pocket could be defined in only a portion of the cover. The pocket 230 is adapted to receive the optional pad 130 of the padding device 100. Alternatively, in additional embodiments the pocket could be formed within the base 110 if the padding device 100 does not include a cover 120. As mentioned previously, the padding device 100 need not include a separate pad located in a pocket because the base or cover themselves could provide the cushioning with an affixed or removable pad.

As shown in FIG. 2, the pad 130 of the illustrated embodiment is generally a rectangular shaped layer of a suitable flexible material, such as fabric, foam, rubber, plastic, etc., however the pad could be shaped differently, and other materials could be used. Preferably, the material that the pad 130 is made out of should also be resilient and retain its cushioning properties after multiple uses. While in the illustrated embodiment, the pad 130 fits within a pocket 230 defined within the cover 120, the pad 130 could fit within a pocket defined within the base 110 or the pad 130 could simply be an padded portion that is integrated within the base 110 or cover 120.

To use the padding device 100 of the illustrated embodiment, the user inserts the pad 130 into the pocket 230 of the cover 120. The cover 120 is then attached to the base 110. The user then grasps the padding device 100 and slips the base 110 over the rung 170 of a ladder. The base 110 generally surrounds and encloses a portion of the step or rung 170 of the ladder, and the cover 120 surrounds and encloses at least a portion of the base. If the user accidentally bumps into the rung 170 of the ladder or intentionally leans against it, the pad 130 of the padding device 100 will cushion the step or rung 170 for the user. As the user moves up or down the ladder to accomplish their task, the padding device 100 can be easily removed with one hand from the rung 170 it was originally located on and be installed onto a different rung.

A second embodiment of the padding device is illustrated in FIG. 4. In the second embodiment, the pair of side wall surfaces 212 and 214 clamp against the front face 174 and back face 178 of the ladder rung, and the interior front wall surface 216 covers the top face 172 of the ladder rung. In this manner, the base 110 substantially encloses the top face 172 while also enclosing at least a portion of both the front face 174 and back face 178 of the ladder rung. In the embodiment illustrated in FIG. 4, the cover 120 encloses a portion of the base and the pad 130 fits within a pocket 230 defined within the cover 120. The padding device 100 of the embodiment shown in FIG. 4 is used in a similar manner as the first embodiment except the user slips the base over the top face 172, front face 174, and back face 178 of the ladder rung instead of the top face 172, front face 174, and bottom face 176 of the ladder.

According to embodiments wherein the padding device 100 is constructed from multiple components that can be assembled together, the separate components can be cleaned or replaced apart from each other if necessary. As a result, if the base 110, cover 120, or pad 130 should ever become dirty, worn or damaged, they can be separately cleaned or replaced. In a similar manner, different bases, covers, and pads could be created that each conform to different types of ladder, such as extension ladders or step ladders, or that accomplish various purposes, such as a waterproof cover and pad for use in jobs in a damp environment, or an absorbent pad or cover, or an extra firm or extra soft pad, or other variations to address specific comfort needs or use requirements of users. These bases, covers, and pads could be interchanged with each other and combined in different combinations due to the component construction of the padding device 100 of this application. For example, separate bases could be constructed for use with specific types of ladders, such as extension ladders or step ladders. Various covers and pads could be constructed in a manner that allows them to be interchangeably used with bases of varying construction.

However, it should be understood that the padding device 100 of this application is not limited to a padding device that includes a separate base, cover, and pad. Rather, the padding device 160 could be constructed in many different ways. For instance, the padding device could be constructed of a base, cover, and pad that are manufactured as one unit and are not capable of being separated or the padding device could include only a base and a cover. The cover itself could be made of a material that could adequately cushion the rung of the ladder. Additionally, the padding device 100 could simply include a base without a cover. The base could be constructed of a suitable material that has enough rigidity to allow the base 110 to be attached to the step or rung 170 of a ladder and yet possesses the requisite cushioning characteristics to make the step or rung of the ladder comfortable for a user. The padding device could also be made up of a base that has a pocket defined within it to house a pad but does not include a cover. Finally, it should be understood that the different components of the padding device are not limited to the shapes and materials disclosed in this application but could be shaped differently or constructed from materials not explicitly set forth in this application.

1. A padding device for use with ladders, the padding device comprising:
a base adapted to be removably engageable with a step or rung of a ladder that has substantially opposing front and back faces and substantially opposing top and bottom faces and a length bounded by a pair of ladder rails, the length being sufficiently sized to support at least one human foot, the base having an opening defined by a pair of opposable side walls, the base and pair of opposable side walls having a length that is at least half the of the length of the step or rung of the ladder, the pair of opposable side walls configured to clamp between them a pair of the opposing faces of the step or rung of the ladder thereby substantially enclosing a portion of the faces of the rung or ladder which are clamped between the pair of opposable side walls and substantially enclosing one of the faces of the step or rung of the ladder which is not clamped between the pair of opposable side walls; and
a padded portion.

2. The padding device of claim 1, wherein the base has a generally C-shaped cross section with a front wall and a pair of side walls projecting from the front wall.

3. The padding device of claim 1, wherein the padded portion is integrated into the base.

4. The padding device of claim 1 further comprising:
a pocket defined within the base; and
wherein the padded portion is received within the pocket defined in the base.

5. The padding device of claim 1, wherein said opening defined by said pair of opposable side walls is defined within substantially the entire length of the base.

6. The padding device of claim 1, wherein the pair of opposable side walls of the base are configured to clamp between them the front face and back face, thereby substantially enclosing the top face and substantially enclosing at least a portion of the front face and back face.

7. The padding device of claim 1, wherein the pair of opposable side walls of the base are configured to clamp between them the top face and bottom face, thereby substantially enclosing the front face and substantially enclosing at least a portion of the top face and bottom face.

8. A padding device for use with ladders, the padding device comprising:
a base, the base being configured to clamp onto the step or rung of a ladder; and
a cover, the cover being secured to said base.

9. The padding device of claim 8, wherein the base contacts a top surface, front surface and bottom surface of a step or rung of a ladder but does not contact a back surface of the step or rung.

10. The padding device of claim 8 wherein all or a portion of the base is padded.

11. The padding device of claim 8 wherein all or a portion of the base is padded.

12. The padding device of claim 8 further comprising a pocket defined within the base or cover, the pocket being adapted for receipt of a pad.

13. The padding device of claim 12 further comprising a pad for insertion into the pocket defined within the base or cover.

14. The padding device of claim 8, wherein the cover is removably secured to the base.

15. The padding device of claim 14, wherein the cover is secured to the base by a plurality of snaps fasteners.

16. The padding device of claim 14, wherein the cover is secured to the base by a hook and loop fastener system.

17. The padding device of claim 14, wherein either of the base or cover has a plurality of slots defined within it and the other of the base or cover has a corresponding plurality of tabs, the tabs fitting within the slots to secure the cover to the base.

18. The padding device of claim 14, wherein either of the base or cover has a groove defined within it and the other of the base or cover has a corresponding projection, the projection fitting into the groove to secure the cover to the base.

19. The padding device of claim 8, wherein the base is made up of a first part and a second part, the first part and second part being adapted to be removably engageable with opposing ends of the length of the step or rung.

20. A padding device for use with ladders, the padding device comprising:
a base, the base having an opening defined by a pair of opposable side walls, the pair of opposable side walls being adapted to be removably engageable with a step or rung of a ladder, the pair of opposable side walls clamping between them a front face and a back face of the step or rung of the ladder, thereby substantially enclosing a top face of the step or rung and at least a portion of the front and back face of the step or rung, the base engaging with generally the entire length of the front face and back face of the step or rung; and
a padded portion.

21. A padding device for use with ladders, the padding device comprising:
a base adapted to be removably engageable with a step or rung of a ladder that has a length bounded by a pair of ladder rails, the length being sufficiently sized to support at least one human foot, the base having an opening defined by a pair of opposable side walls, the base and pair of opposable side walls having a length that is at least half the of the length of the step or rung of the ladder, the pair of opposable side walls configured to clamp between them the step or rung thereby substantially enclosing a portion of at least half of the length of the step or rung of the ladder; and
a padded portion.
